(19) United States
(12) Patent Application Publication
(10) Pub. No.: US 2025/0371414 A1
(43) Pub. Date: Dec. 4, 2025

(54) MODEL TRAINING METHOD AND APPARATUS, SYSTEM, AND STORAGE MEDIUM

(71) Applicant: Douyin Vision Co., Ltd., Beijing (CN)

(72) Inventors: Yilan WANG, Beijing (CN); Junyuan XIE, Beijing (CN); Qi LIU, Beijing (CN); Zihui ZHANG, Beijing (CN); Di WU, Beijing (CN)

(21) Appl. No.: 18/869,802

(22) PCT Filed: Sep. 13, 2023
(86) PCT No.: PCT/CN2023/118478

§ 371 Date: Nov. 26, 2024

(30) Foreign Application Priority Data
Sep. 14, 2022 (CN) 202211117189.3

(51) Int. Cl. G06N 20/00

(52) U.S. Cl. CPC G06N 20/00

(57) ABSTRACT

A model training method and apparatus, a system, and a storage medium. The model training method includes: obtaining a cloud training feature; training the cloud submodel by using the cloud training feature to obtain a cloud output result of the cloud submodel; sending the cloud output result and current parameters of the M terminal submodels to at least one terminal; receiving terminal gradients respectively output by N terminal submodels in the M terminal submodels that are output by the at least one terminal; calculating and obtaining a parameter gradient of the cloud submodel based on the terminal gradients respectively output by the N terminal submodels and the cloud output result; and adjusting current parameters of the N terminal submodels and a current parameter of the cloud submodel by using the parameter gradients of the N terminal submodels and the parameter gradient of the cloud submodel.

The present application claims priority to Chinese Patent Application No. 202211117189.3, filed on Sep. 14, 2022, which is incorporated herein by reference in its entirety as a part of the present application.

### TECHNICAL FIELD

Embodiments of the present disclosure relate to a model training method and apparatus, a model training system, and a non-transitory computer-readable storage medium.

### BACKGROUND

Federated learning is a distributed machine learning technology. The core idea of federated learning is to perform distributed model training between a plurality of data sources with local data, and construct a global model based on virtual fused data only by exchanging model parameters or intermediate results without exchanging local data between the plurality of data sources, to implement data sharing across institutions, thereby implementing a balance between data privacy protection and data sharing computing, that is, an application mode of “data available but invisible” and “data immovable but model movable”.

### SUMMARY

This section is provided to give a brief overview of concepts, which will be described in detail in the following sections. This section is neither intended to identify key or necessary features of the claimed technical solutions, nor is it intended to be used to limit the scope of the claimed technical solutions.

At least one embodiment of the present disclosure provides a model training method, which is applied to a server and is used for training a machine learning model, where the machine learning model includes a cloud submodel and M terminal submodels, the cloud submodel is run on the server, the M terminal submodels are run on at least one terminal, M is a positive integer, and the model training method includes: obtaining a cloud training feature; training the cloud submodel by using the cloud training feature to obtain a cloud output result of the cloud submodel; sending the cloud output result and current parameters of the M terminal submodels to the at least one terminal; receiving terminal gradients respectively output by N terminal submodels in the M terminal submodels that are output by the at least one terminal, where N is a positive integer and less than or equal to M, and a terminal gradient output by each of the N terminal submodels includes a parameter gradient of the terminal submodel and a cloud output gradient; calculating and obtaining a parameter gradient of the cloud submodel based on the terminal gradients respectively output by the N terminal submodels and the cloud output result; and adjusting current parameters of the N terminal submodels and a current parameter of the cloud submodel by using the parameter gradients of the N terminal submodels and the parameter gradient of the cloud submodel.

At least one embodiment of the present disclosure provides a model training method, which is applied to a first terminal and is used for training a machine learning model, where the machine learning model includes a cloud submodel and a first terminal submodel, the cloud submodel is run on a server, the first terminal submodel is run on the first terminal, and the model training method includes: obtaining at least one terminal training sample, where each terminal training sample includes a terminal training feature and a sample label; sending a training request to the server based on the at least one terminal training sample; receiving, from the server, a cloud output corresponding to the at least one terminal training sample and a current parameter of the first terminal submodel; training the first terminal submodel by using the cloud output, the current parameter of the first terminal submodel, and the at least one terminal training sample to obtain a terminal gradient output by the first terminal submodel, where the terminal gradient includes a parameter gradient of the first terminal submodel and a cloud output gradient; and outputting the terminal gradient to the server, for the server to calculate and obtain a parameter gradient of the cloud submodel based on the terminal gradient and the cloud output, and to adjust the current parameter of the first terminal submodel and a current parameter of the cloud submodel by using the parameter gradient of the first terminal submodel and the parameter gradient of the cloud submodel.

At least one embodiment of the present disclosure further provides a model training apparatus, including: one or more memories storing computer-executable instructions in a non-transitory manner; and one or more processors configured to run the computer-executable instructions, where the computer-executable instructions, when run on the one or more processors, implement the model training method according to any embodiment of the present disclosure.

At least one embodiment of the present disclosure further provides a model training system, which is configured to train a machine learning model and includes: at least one terminal and a server, where the machine learning model includes a cloud submodel and M terminal submodels, the cloud submodel is run on the server, the M terminal submodels are run on the at least one terminal, M is a positive integer, and the server is configured to: obtain a cloud training feature; train the cloud submodel by using the cloud training feature to obtain a cloud output result of the cloud submodel; send the cloud output result and current parameters of the M terminal submodels to the at least one terminal; receive terminal gradients respectively output by N terminal submodels in the M terminal submodels that are output by the at least one terminal, where N is a positive integer and less than or equal to M, and a terminal gradient output by each of the N terminal submodels includes a parameter gradient of the terminal submodel and a cloud output gradient; calculate and obtain a parameter gradient of the cloud submodel based on the terminal gradients respectively output by the N terminal submodels and the cloud output result; and adjust current parameters of the N terminal submodels and a current parameter of the cloud submodel by using the parameter gradients of the N terminal submodels and the parameter gradient of the cloud submodel; and each of the at least one terminal is configured to: obtain at least one terminal training sample, where each terminal training sample includes a terminal training feature and a sample label, and the cloud training feature includes at least one sub-cloud training feature in a one-to-one correspondence with the at least one terminal training sample; receive, from the server, a cloud output corresponding to the at least one terminal training sample and a current parameter of a terminal submodel run on the terminal, where the cloud output result includes the cloud output; train the terminal submodel run on the terminal by using the cloud output, the current parameter of the terminal submodel run on the terminal, and the at least one terminal training sample to obtain a terminal gradient output by the terminal submodel run on the terminal; and output the terminal gradient output by the terminal submodel run on the terminal to the server.

At least one embodiment of the present disclosure further provides a non-transitory computer-readable storage medium, where the non-transitory computer-readable storage medium stores computer-executable instructions, and the computer-executable instructions, when executed by a processor, implement the model training method according to any embodiment of the present disclosure.

### BRIEF DESCRIPTION OF THE DRAWINGS

The above and other features, advantages and aspects of embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1A is a schematic diagram of a machine learning model according to at least one embodiment of the present disclosure;

FIG. 1B is a schematic diagram of another machine learning model according to at least one embodiment of the present disclosure;

FIG. 2 is a schematic flowchart of a model training method according to at least one embodiment of the present disclosure;

FIG. 3 is a schematic diagram of interaction between a terminal and a server according to at least one embodiment of the present disclosure;

FIG. 4 is a schematic diagram of another model training method according to at least one embodiment of the present disclosure;

FIG. 5 is a schematic diagram of a model training system according to at least one embodiment of the present disclosure;

FIG. 6 is a schematic diagram of an overall process of model training performed by the model training system according to at least one embodiment of the present disclosure;

FIG. 7 is an example diagram of a specific training process of model training performed by the model training system according to at least one embodiment of the present disclosure;

FIG. 8 is an example diagram of a specific training process of model training performed by the model training system according to at least one embodiment of the present disclosure;

FIG. 9 is a schematic block diagram of a model training apparatus according to at least one embodiment of the present disclosure;

FIG. 10 is a schematic diagram of a non-transitory computer-readable storage medium according to at least one embodiment of the present disclosure; and

FIG. 11 is a schematic diagram of a hardware structure of an electronic device according to at least one embodiment of the present disclosure.

### DETAILED DESCRIPTION OF EMBODIMENTS

Embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish between different apparatuses, modules, or units, and are not used to limit the sequence of functions performed by these apparatuses, modules, or units or interdependence.

It should be noted that modifiers such as “one” and “a plurality of” mentioned in the present disclosure are illustrative and not restrictive, and those skilled in the art should understand that the modifiers should be understood as “one or more” unless the context clearly indicates otherwise.

The names of messages or information exchanged between a plurality of apparatuses in the implementations of the present disclosure are used for illustrative purposes only, and are not used to limit the scope of these messages or information.

With the continuous improvement of privacy protection policies and users' awareness of privacy protection, especially the continuous strengthening of terminal privacy protection, new challenges are brought to large-scale online recommendation systems based on deep network models. User privacy data can no longer be tracked and stored centrally. Traditional model training methods first need to aggregate data, and then perform model training based on the aggregated data, thus the traditional model training methods cannot adapt to such scenarios. Federated learning technology based on user privacy and data security protection is gradually receiving attention.

Federated learning refers to a method for jointly performing machine learning modeling by a plurality of participants (terminals) with data ownership. In a federated learning process, a participant with data does not need to expose its own data to a central server (also referred to as a parameter server), but jointly completes the model training process through parameter or gradient updates. Therefore, the federated learning can protect user privacy data and complete a modeling training process.

In a large-scale online recommendation system scenario, a machine learning model is often very large, and a large amount of computing power is required to quickly train the model. In traditional model training methods, user data is stored in a cloud, and then a server with powerful computing power is used to quickly train the model. The large model also corresponds to a large amount of training data, which may result in high storage pressure on the server. In order to maintain a balance between the model effect and the training speed, batch training is often required.

At least one embodiment of the present disclosure provides a model training method, which is applied to a server and is used for training a machine learning model. The machine learning model includes a cloud submodel and M terminal submodels, the cloud submodel is run on the server, the M terminal submodels are run on at least one terminal, M is a positive integer, and the model training method includes: obtaining a cloud training feature; training the cloud submodel by using the cloud training feature to obtain a cloud output result of the cloud submodel; sending the cloud output result and current parameters of the M terminal submodels to the at least one terminal; receiving terminal gradients respectively output by N terminal submodels in the M terminal submodels that are output by the at least one terminal, where N is a positive integer and less than or equal to M, and a terminal gradient output by each of the N terminal submodels includes a parameter gradient of the terminal submodel and a cloud output gradient; calculating and obtaining a parameter gradient of the cloud submodel based on the terminal gradients respectively output by the N terminal submodels and the cloud output result; and adjusting current parameters of the N terminal submodels and a current parameter of the cloud submodel by using the parameter gradients of the N terminal submodels and the parameter gradient of the cloud submodel.

The model training method provided in the at least one embodiment of the present disclosure splits the machine learning model into the cloud submodel and the terminal submodels, to implement federated machine learning between the server and the terminal, implement user privacy and data security protection, and solve a problem that a model on a terminal such as an in-vehicle infotainment device is too large to be trained. In addition, different terminal submodels may be used for different terminals, so that the model training process is more flexible and the application scenarios are more extensive. The server can perform the federated machine learning with a plurality of terminals at the same time, thereby greatly improving the model training speed and saving the model training time on the basis of ensuring the model effect of the machine learning model obtained through training.

At least one embodiment of the present disclosure further provides a model training apparatus, a model training system, and a non-transitory computer-readable storage medium. The model training method may be applied to the model training apparatus provided in the embodiments of the present disclosure, and the model training apparatus may be configured on an electronic device. The electronic device may be a fixed terminal, a mobile terminal, or the like.

The embodiments of the present disclosure are described in detail below with reference to the drawings, but the present disclosure is not limited to these specific embodiments. In order to keep the following description of the embodiments of the present disclosure clear and concise, detailed descriptions of some known functions and known components are omitted in the present disclosure.

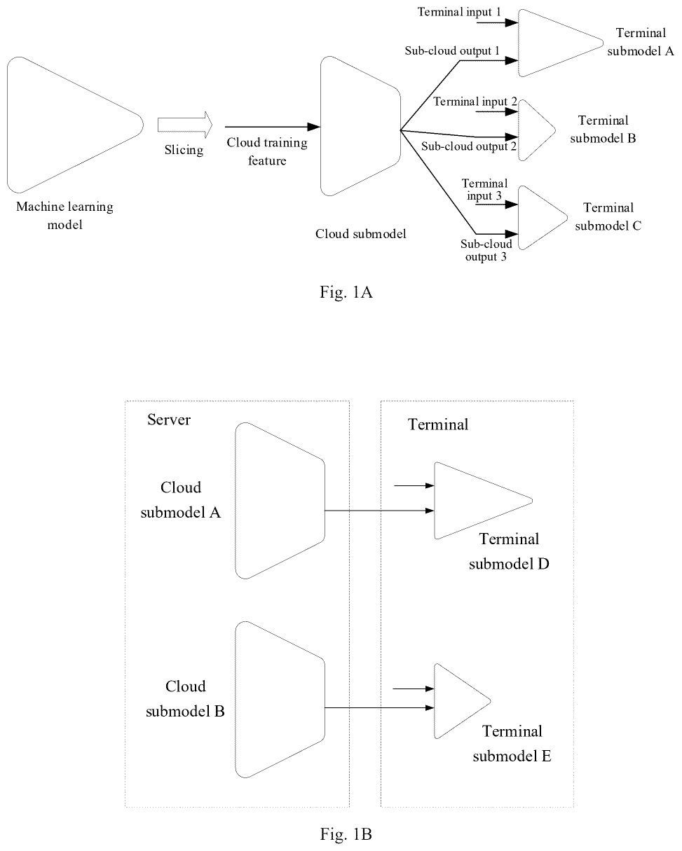

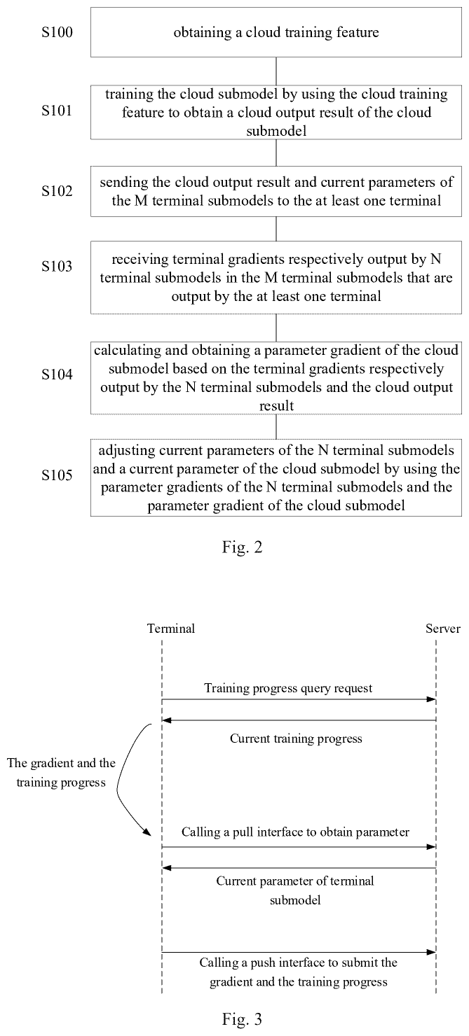

FIG. 1A is a schematic diagram of a machine learning model according to at least one embodiment of the present disclosure, FIG. 1B is a schematic diagram of another machine learning model according to at least one embodiment of the present disclosure, and FIG. 2 is a schematic flowchart of a model training method according to at least one embodiment of the present disclosure.

For example, in some embodiments, the model training method provided in the embodiments of the present disclosure may be applied to a server, that is, the model training method is implemented by the server. The server may be a cloud server or the like, and the server may include a device such as a central processing unit (CPU) or the like having a data processing capability and/or a program execution capability.

For example, the model training method may be used to train a machine learning model, and the machine learning model may be a neural network model or the like.

Starting from a slicing solution, the present disclosure splits a large machine learning model, of which the modeling is completed, into two parts by slicing. A first part is a terminal submodel with a small model structure executed by a terminal, and a second part is a cloud submodel with a large model structure executed by a server. The terminal submodel is relatively simple and is composed of several uppermost neural network layers of the original machine learning model, thereby being suitable for a terminal with a small computing power and avoiding an increase in the computing power burden on the terminal. Different terminal submodels may be used for different terminals, that is, the terminal submodels on the terminals may use different structures as required. In addition, different inputs of the terminal submodels may be set according to different terminals. The cloud submodel includes most structures of the machine learning model. Therefore, the cloud submodel is relatively complex and is mainly executed on the server, and the model training is completed by using the powerful computing power of the server. The cloud submodel and the terminal submodels cooperate to complete the federated training process.

For example, the machine learning model may include a cloud submodel and M terminal submodels. FIG. 1A shows three terminal submodels, namely a terminal submodel A, a terminal submodel B, and a terminal submodel C. Each terminal submodel and the cloud submodel together constitute a complete model, and the complete model may be used to implement a predetermined function, for example, a classification function or a prediction function.

For example, the M terminal submodels are run on at least one terminal, M is a positive integer, and at least one terminal submodel may be run on each terminal. For example, in an example, one terminal submodel may be run on each terminal, and in this case, the M terminal submodels are run on M terminals respectively. For example, the three terminal submodels shown in FIG. 1A may be run on three terminals respectively. For example, in some other examples, a plurality of terminal submodels may be run on one terminal. For example, at least two terminal submodels of the three terminal submodels as shown in FIG. 1A may also be run on the same terminal. For example, the terminal submodel A and the terminal submodel B as shown in FIG. 1A are executed by the same terminal.

For example, the cloud submodel is run on the server. At least one cloud submodel may be run on each server. In an example, as shown in FIG. 1B, a cloud submodel A and a terminal submodel D together constitute a complete model, a cloud submodel B and a terminal submodel E together constitute a complete model, and the cloud submodel A and the cloud submodel B may be run on the same server, and the terminal submodel D and the terminal submodel E may be run on the same terminal or different terminals.

For example, each cloud submodel may correspond to at least one terminal submodel. As shown in FIG. 1A, one cloud submodel may correspond to three terminal submodels. In this case, an output of the cloud submodel may be transmitted to the three terminal submodels. As shown in FIG. 1B, one cloud submodel corresponds to one terminal submodel. The cloud submodel A corresponds to the terminal submodel D, and the cloud submodel B corresponds to the terminal submodel E. Therefore, an output of the cloud submodel A is transmitted to the terminal submodel D, and an output of the cloud submodel B is transmitted to the terminal submodel E.

It should be noted that in the embodiments of the present disclosure, “a cloud submodel corresponds to a terminal submodel” indicates that the terminal submodel and the cloud submodel can together constitute a complete model.

For example, inputs of the M terminal submodels match an output of the cloud submodel, that is, the cloud submodel outputs feature maps with a same size to the M terminal submodels. For example, as shown in FIG. 1A, a size of a sub-cloud output 1, a size of a sub-cloud output 2, and a size of a sub-cloud output 3 are the same.

For example, an input of each terminal submodel may include a terminal input and a sub-cloud output. As shown in FIG. 1A, an input of the terminal submodel A may include the sub-cloud output 1 and a terminal input 1, an input of the terminal submodel B may include the sub-cloud output 2 and a terminal input 2, and an input of the terminal submodel C may include the sub-cloud output 3 and a terminal input 3. The terminal input may be a terminal training feature (described below) stored on a terminal on which the terminal submodel is run.

For example, the M terminal submodels implement a same objective, for example, adjusting a temperature or the like.

For example, the M terminal submodels may be run on different terminals, and the different terminals may be a same type of terminals applied in different scenarios, or may be different types of terminals applied in a same scenario or different scenarios. For example, in the example shown in FIG. 1A, the terminal submodel A may be run on a terminal 1, the terminal submodel B may be run on a terminal 2, and the terminal submodel C may be run on a terminal 3. In an example, the terminal 1, the terminal 2, and the terminal 3 may all be air conditioners, the terminal 1 may be an in-vehicle air conditioner, the terminal 2 may be an air conditioner in a living room, and the terminal 3 may be an air conditioner in a bedroom. In this case, an objective implemented by the terminal submodel A, the terminal submodel B, and the terminal submodel C may all be adjusting a temperature.

For example, each terminal and the server may be separately provided and connected to each other through a network for communication. The network may include a wireless network, a wired network, and/or any combination of the wireless network and the wired network. The network may include a local area network, the Internet, a telecommunications network, an Internet of Things (IoT) based on the Internet and/or the telecommunications network, and/or any combination of the foregoing networks. The wired network may communicate using, for example, twisted pair, coaxial cable, or optical fiber transmission. The wireless network may use, for example, a 3G/4G/5G mobile communication network, Bluetooth, Zigbee, WiFi, or another communication method. The present disclosure is not limited to the type and function of the network.

For example, the terminal may be various mobile terminals, fixed terminals, etc. For example, the terminal may include an application (App) of a mobile terminal. The mobile terminal may be a tablet computer, an in-vehicle device, a notebook computer, smart glasses, a smart watch, an in-vehicle infotainment device, or the like. The fixed terminal may be a desktop computer, a smart appliance (for example, a smart air conditioner, a smart refrigerator, a smart purifier, a smart switch, a smart gateway, a smart rice cooker, or the like), or the like.

As shown in FIG. 2, the model training method may include the following steps S100 to S105. In step S100, a cloud training feature is obtained.

In step S101, the cloud submodel is trained by using the cloud training feature to obtain a cloud output result of the cloud submodel.

In step S102, the cloud output result and current parameters of the M terminal submodels are sent to the at least one terminal.

In step S103, terminal gradients respectively output by N terminal submodels in the M terminal submodels that are output by the at least one terminal are received. For example, N is a positive integer and less than or equal to M, and a terminal gradient output by each of the N terminal submodels includes a parameter gradient of the terminal submodel and a cloud output gradient.

In step S104, a parameter gradient of the cloud submodel is calculated and obtained based on the terminal gradients respectively output by the N terminal submodels and the cloud output result.

In step S105, current parameters of the N terminal submodels and a current parameter of the cloud submodel are adjusted by using the parameter gradients of the N terminal submodels and the parameter gradient of the cloud submodel.

Steps S100 to S101 represent a forward propagation process of the cloud submodel, and steps S103 to S104 represent a backward propagation process of the cloud submodel.

For example, in step S100, the cloud training feature may include at least one sub-cloud training feature corresponding to each terminal. The sub-cloud training feature may be information that does not involve terminal privacy, such as information that has been made public by the terminal and/or information authorized by the terminal to the server. In some examples, the terminal may be an in-vehicle air conditioner. In this case, the sub-cloud training feature corresponding to the terminal may be information such as an ambient temperature, an address, and a time of a location where a motor vehicle to which the in-vehicle air conditioner belongs is located. Specific content of the sub-cloud training feature may be determined based on an actual situation, which is not limited in the present disclosure.

For example, the at least one sub-cloud training feature may be stored in the server. When the server receives a training request sent by the terminal, the server may obtain the sub-cloud training feature corresponding to the terminal based on information such as identification information in the training request.

In some embodiments, the at least one terminal includes a first terminal, and step S100 may include: receiving a training request sent by the first terminal; and obtaining at least one first sub-cloud training feature based on the training request sent by the first terminal. The cloud training feature includes the at least one first sub-cloud training feature, and the at least one first sub-cloud training feature corresponds to the first terminal.

For example, the training request sent by the first terminal includes identification information and a sample identifier of the first terminal, and the server may obtain the at least one first sub-cloud training feature based on the identification information and the sample identifier of the first terminal.

It should be noted that “sample identifier” may represent identification information of a terminal training sample (which will be described below). Based on the sample identifier, which terminal training samples are used for training may be determined, so that the server may obtain the sub-cloud training feature corresponding to the terminal training samples for training.

Each terminal periodically (at intervals of a period of time, the period of time is at a minute level, for example, the period of time may be one minute, two minutes, five minutes, etc.) continuously queries the server for model training. During this period of time, generally, a new terminal training feature added to each terminal is not many. When tens of millions of terminals need to perform model training with the server, at each moment, a new sample amount of each terminal device is very small. If the server performs training separately for each terminal, resources of the server are consumed greatly, and the training speed is reduced greatly. Therefore, the model training method provided in the embodiments of the present disclosure may perform combined training, that is, terminal training features of a plurality of terminals are combined to form a batch for training, thereby improving the training speed, saving the training time, optimizing or reducing resource consumption of the server, and solving a problem of insufficient samples at the terminal through a real-time sample combining solution.

In some other embodiments, the at least one terminal includes a first terminal and a second terminal, and step S100 may include: receiving a training request sent by the first terminal; obtaining at least one first sub-cloud training feature based on the training request sent by the first terminal; receiving a training request sent by the second terminal; obtaining at least one second sub-cloud training feature based on the training request sent by the second terminal; and performing combining processing on the at least one first sub-cloud training feature and the at least one second sub-cloud training feature to obtain the cloud training feature.

In the embodiments of the present disclosure, the server may perform federated machine learning with a plurality of terminals at the same time, thereby greatly improving the model training speed, reducing resource consumption of the server, and reducing the pressure on the server.

For example, the training request sent by the second terminal includes identification information and a sample identifier of the second terminal.

For example, an absolute value of a time difference between a time when the training request is sent by the first terminal and a time when the training request is sent by the second terminal is within a time difference range. For example, the preset time difference range may be 500 milliseconds or the like, and is specifically set according to an actual situation. In the embodiments of the present disclosure, the sub-cloud training features acquired within a specific time difference range may be combined for processing, thereby improving the training speed and saving the training time.

For example, step S101 may include: obtaining a current parameter of the cloud submodel; and training the cloud submodel with the current parameters by using the cloud training feature to obtain the cloud output result of the cloud submodel. For example, the current parameter of the cloud submodel represents a parameter of the cloud submodel when obtaining the cloud training feature. Since the parameters of the cloud submodel are continuously updated and optimized during the training process, when the forward propagation of the cloud submodel is performed, the latest updated parameters (namely, the current parameters) of the cloud submodel need to be obtained, and then the forward propagation process is performed based on the cloud submodel with the latest updated parameters.

For example, the cloud submodel may process the cloud training feature to obtain the cloud output result. The cloud output result may include at least one sub-cloud output, and each sub-cloud output corresponds to one sub-cloud training feature (for example, the foregoing first sub-cloud training feature or the foregoing second sub-cloud training feature). As shown in FIG. 1A, the cloud output result includes the sub-cloud output 1, the sub-cloud output 2, and the sub-cloud output 3.

For example, the server may train a plurality of terminals at the same time. In some embodiments, the M terminal submodels include a first terminal submodel and a second terminal submodel, the at least one terminal includes a first terminal and a second terminal, the first terminal submodel is run on the first terminal, and the second terminal submodel is run on the second terminal. Step S102 may include: performing splitting processing on the cloud output result to obtain a first cloud output corresponding to the first terminal submodel and a second cloud output corresponding to the second terminal submodel; obtaining a current parameter of the first terminal submodel and a current parameter of the second terminal submodel; and transmitting the first cloud output and the current parameter of the first terminal submodel to the first terminal, and transmitting the second cloud output and the current parameter of the second terminal submodel to the second terminal.

In the embodiments of the present disclosure, different terminal submodels (for example, the foregoing first terminal submodel and the foregoing second terminal submodel) may be used for different terminals, so that the model training process is more flexible and the application scenarios are more extensive. In addition, different terminal submodels may be trained at the same time, thereby further saving the model training time.

For example, the first cloud output may include at least one sub-cloud output, and the second cloud output may include at least one sub-cloud output.

For example, the current parameters of each terminal submodel represent parameters of the terminal submodel when obtaining the cloud training feature.

As shown in FIG. 1A, an example of the first terminal submodel may be the terminal submodel A, an example of the second terminal submodel may be the terminal submodel B, an example of the first cloud output may be the sub-cloud output 1, and an example of the second cloud output may be the sub-cloud output 2. The sub-cloud output 1 is transmitted to the first terminal and serves as a part of an input of the terminal submodel A, and the sub-cloud output 2 is transmitted to the second terminal and serves as a part of an input of the terminal submodel B.

For example, each terminal may participate in training processes of a plurality of terminal submodels at the same time. In some embodiments, the M terminal submodels include the first terminal submodel and a third terminal submodel, a structure of the first terminal submodel may be different from a structure of the third terminal submodel, the at least one terminal includes the first terminal, and the first terminal submodel and the third terminal submodel are both run on the first terminal. Step S102 may include: performing splitting processing on the cloud output result to obtain a first cloud output corresponding to the first terminal submodel and a third cloud output corresponding to the third terminal submodel; obtaining a current parameter of the first terminal submodel and a current parameter of the third terminal submodel; and transmitting the first cloud output, the third cloud output, the current parameter of the first terminal submodel, and the current parameter of the third terminal submodel to the first terminal.

For example, the third cloud output may include at least one sub-cloud output.

As shown in FIG. 1A, an example of the first terminal submodel may be the terminal submodel A, and an example of the third terminal submodel may be the terminal submodel C. An example of the first cloud output may be the sub-cloud output 1, and an example of the third cloud output may be the sub-cloud output 3. Both the sub-cloud output 1 and the sub-cloud output 3 may be transmitted to the first terminal. However, the sub-cloud output 1 serves as a part of an input of the terminal submodel A, and the sub-cloud output 3 serves as a part of an input of the terminal submodel C.

In the foregoing embodiments, the first terminal runs the plurality of terminal submodels as an example. However, the present disclosure is not limited thereto, and the second terminal may also run the plurality of terminal submodels. For a specific operation process, refer to the related descriptions above. Details of the same parts will not be repeated.

For example, in step S103, the terminal gradients respectively output by the N terminal submodels may be received from a terminal running the N terminal submodels in the at least one terminal. In some embodiments, in step S103, gradient information transmitted from the terminal may be received within a feedback time range. If gradient information fed back by a specific terminal is not received within the feedback time range, it indicates that the terminal is disconnected (in this case, N is less than M), and therefore parameters of the terminal submodel run on the terminal are not adjusted in the current training process. For example, the feedback time range may be 8 seconds, 10 seconds, 20 seconds, or the like, and may be set according to an actual situation.

For example, in step S103, the parameter gradient of the terminal submodel represents a gradient of a parameter of each layer in the terminal submodel, and the cloud output gradient of the terminal submodel represents a gradient of the cloud output received by the terminal submodel. In an example, the first terminal submodel receives the first cloud output, and therefore the cloud output gradient of the first terminal submodel represents a gradient of the first cloud output.

For example, in step S104, the parameter gradient of the cloud submodel may be calculated based on the cloud output gradients respectively output by the N terminal submodels and the cloud output result. In some embodiments, M is greater than 1, N is greater than 1, and step S104 may include: performing combining processing on the cloud output gradients of the N terminal submodels to obtain a combined output gradient; and calculating and obtaining the parameter gradient of the cloud submodel based on the combined output gradient and the cloud output result.

It should be noted that when N is 1, the gradient combining process may be omitted, and the parameter gradient of the cloud submodel may be directly calculated based on the cloud output gradient output by the terminal submodel and the cloud output result.

For example, in some embodiments, step S104 may further include: performing combining processing on the parameter gradients of the N terminal submodels to obtain a combined parameter gradient.

For example, in some embodiments, step S105 may include: adjusting the current parameters of the N terminal submodels by using the parameter gradients of the N terminal submodels; and adjusting the current parameter of the cloud submodel by using the parameter gradient of the cloud submodel.

After the parameters of the N terminal submodels and the cloud submodel are adjusted, the adjusted parameters of the N terminal submodels may be stored in the server as the current parameters of the N terminal submodels, and the adjusted parameter of the cloud submodel may be stored in the server as the current parameter of the cloud submodel.

For example, parameters of the machine learning model may be adjusted by using a parameter optimizer.

The foregoing steps S100 to S105 represent a complete training process.

In order to avoid the need for each terminal to manage a training progress for each terminal submodel, and avoid the complexity of the server resetting the training progress of the terminal when the machine learning model is rolled back to a specific day, in the embodiments of the present disclosure, training progress information of each terminal may be stored in a parameter of each terminal submodel, and used as a part of the parameter of the terminal submodel and stored in the server. Training progress of the plurality of terminal submodels run on each terminal may be different. Each terminal submodel only needs to store one number of training progress for each terminal, so that the training progress of the terminal submodel is stored by the server on the basis of almost no increase in a data transmission amount and a data storage amount, to solve the problem of repeated training of model data, further improve the training speed of the model, and save the training time of the model.

Each terminal may participate in the training of the plurality of terminal submodels, and each terminal submodel needs to record trained data for each terminal. When the model is rolled back, a training progress record of all terminals of the model needs to be rolled back.

For example, the M terminal submodels correspond to M pieces of stored training progress information one by one, respectively, and the M pieces of stored training progress information are stored in the server.

For example, in some embodiments, the model training method further includes: for each of the at least one terminal: receiving, from the terminal, current training progress information of each terminal submodel that is run on the terminal; and adjusting the stored training progress information corresponding to each terminal submodel based on the current training progress information.

For example, adjusting the stored training progress information corresponding to each terminal submodel based on the current training progress information may include: setting the stored training progress information corresponding to the terminal submodel as the current training progress information of the terminal submodel. In this way, the stored training progress information corresponding to the terminal submodel indicates a current training progress of the terminal submodel.

Each terminal may separately maintain the training progress corresponding to the terminal. The training progress is a strictly increasing number (which may be a timestamp, a number accumulated on the terminal, or the like). On the terminal, when each terminal training sample is generated, a unique training progress identifier may be set for the terminal training sample. For example, in an example, the training progress identifier may be a timestamp when the terminal training sample is generated.

For example, each terminal stores a training sample set for training all terminal submodels run on the terminal, the training sample set includes a plurality of terminal training samples, each terminal training sample includes a terminal training feature and a sample label, the terminal training features in the plurality of terminal training samples are sequentially generated, and each terminal training sample has a corresponding training progress identifier. For example, the current training progress information of each terminal submodel represents a training progress identifier of a terminal training sample that is most recently generated in all terminal training samples that are used for training each terminal submodel in the training sample set. For another example, the current training progress information of each terminal submodel represents a training progress identifier of a terminal training sample that is earliest generated in all terminal training samples that are not used for training each terminal submodel in the training sample set.

It should be noted that all terminal submodels run on the terminal may share a same training sample set, or different terminal submodels run on the terminal may correspond to different training sample sets, respectively.

For example, the terminal training sample may be preset based on experience, or may be generated in real time as the terminal is used.

For example, in some embodiments, the model training method further includes: receiving a training progress query request sent by each terminal, the training progress query request corresponds to a terminal submodel run on the corresponding terminal; obtaining, based on the training progress query request, the stored training progress information corresponding to the terminal submodel; and outputting the stored training progress information to the corresponding terminal, for the corresponding terminal to perform a sample screening operation based on the stored training progress information. For example, in response to the sample screening operation obtaining at least one terminal training sample, the corresponding terminal sends a training request to the server to perform model training; and in response to the sample screening operation not obtaining the terminal training sample, the model training is not performed.

FIG. 3 is a schematic diagram of interaction between a terminal and a server according to at least one embodiment of the present disclosure.

A terminal submodel run on the terminal may correspond to a plurality of terminal training samples. At a specific moment, the plurality of terminal training samples include a terminal training sample 1 to a terminal training sample 9 that are sequentially generated. As shown in FIG. 3, at the specific moment, the terminal may send a training progress query request to the server to query a current training progress of the terminal submodel in the terminal. The server may obtain stored training progress information (namely, the current training progress of the terminal submodel) of the terminal submodel based on the training progress query request, and transmit the stored training progress information to the corresponding terminal. For example, if the stored training progress information of the terminal submodel indicates that the terminal training sample 1 to the terminal training sample 5 have been used for training the terminal submodel, the current training progress of the terminal submodel may be a training progress identifier corresponding to the terminal training sample 5. Then, the terminal performs a sample screening operation based on the stored training progress information to screen out terminal training samples greater than the current training progress.

In this case, the terminal training sample 6 to the terminal training sample 9 are obtained through screening. Then, the corresponding terminal sends a training request to the server based on information (sample identifiers or the like) of some terminal training samples (for example, the terminal training sample 6 to the terminal training sample 8) that meet a condition to request for performing model training, and may further, for example, call a pull interface to obtain a current parameter of the terminal submodel and a cloud output corresponding to the terminal submodel from the server. Finally, the terminal may, for example, call a push interface to return the current training progress of the terminal submodel and a terminal gradient output by the terminal submodel to the server, so that the server adjusts parameters and adjusts the stored training progress information corresponding to the terminal submodel based on the current training progress of the terminal submodel. After the current training process ends, the current training progress of the terminal submodel becomes a training progress identifier corresponding to the terminal training sample 8.

When the terminal sends the training progress query request to the server again to initiate training, terminal training samples that have completed training in a previous round may be filtered, that is, the terminal training sample 1 to the terminal training sample 8 may be filtered, and therefore the terminal submodel is trained based on the terminal training sample 9.

For example, the terminal may set a terminal sample threshold for each terminal submodel, and the terminal sample threshold represents a maximum value of a number of terminal training samples that can be used to train the terminal submodel in each training process. That is, the number of terminal training samples used to train the terminal submodel in each training process cannot exceed the terminal sample threshold.

For example, the server may set a cloud sample threshold for each terminal submodel, and the cloud sample threshold represents a maximum value of a number of cloud training features that can be used to train the terminal submodel in each training process. That is, the number of the cloud training features that are used to train the terminal submodel in each training process cannot exceed the cloud sample threshold.

It should be noted that the terminal sample threshold and the cloud sample threshold may be the same or different.

For example, in an example, a terminal sample threshold set by the terminal for the terminal submodel may be 8, and a cloud sample threshold set by the server for the terminal submodel may be 6. In this case, in one training process, the corresponding terminal sends a training request to the server, where the training request indicates to train the terminal submodel by using eight terminal training samples. In an example, a training sample set may include a terminal training sample 1 to a terminal training sample 20, and the eight terminal training samples may be a terminal training sample 10 to a terminal training sample 17. In this case, since a cloud sample threshold corresponding to the terminal submodel is 6, the server obtains six cloud training features respectively corresponding to the first six terminal training samples (namely, the terminal training sample 10 to the terminal training sample 15) in the eight terminal training samples for the training process. Correspondingly, in the terminal, the terminal submodel is trained by using the first six terminal training samples (namely, the terminal training sample 10 to the terminal training sample 15) in the eight terminal training samples. In this case, the current training progress information corresponding to the terminal submodel is a sample identifier corresponding to the terminal training sample 15.

In the model training method provided in the embodiments of the present disclosure, an online time of each terminal cannot be controlled. Each terminal, when being online, accesses the server at regular intervals to check whether there is a machine learning model being trained, and then uploads information (excluding sensitive information) of training data to the server, so that the server obtains the cloud training feature for model training.

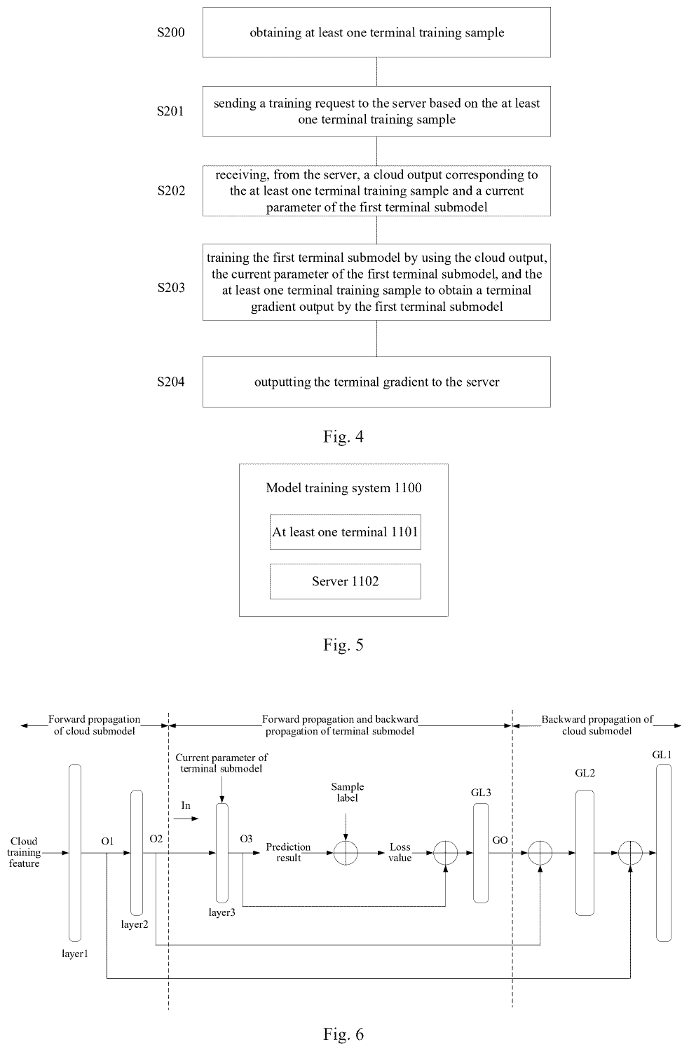

FIG. 4 is a schematic diagram of another model training method according to at least one embodiment of the present disclosure.

For example, in some embodiments, the model training method provided in the embodiments of the present disclosure may be applied to a terminal (for example, a first terminal), that is, the model training method is implemented by the terminal. For a related description of the terminal, refer to the description in the foregoing embodiments.

For example, the machine learning model includes a cloud submodel and a first terminal submodel, the cloud submodel is run on the server, and the first terminal submodel is run on the first terminal. It should be noted that more terminal submodels may also be run on the first terminal.

As shown in FIG. 4, the model training method may include the following steps S200 to S203.

In step S200, at least one terminal training sample is obtained. For example, each terminal training sample includes a terminal training feature and a sample label.

In step S201, a training request is sent to the server based on the at least one terminal training sample.

In step S202, a cloud output corresponding to the at least one terminal training sample and a current parameter of the first terminal submodel are received from the server. For example, the cloud output includes at least one sub-cloud output in a one-to-one correspondence with the at least one terminal training sample.

In step S203, the first terminal submodel is trained by using the cloud output, the current parameter of the first terminal submodel, and the at least one terminal training sample to obtain a terminal gradient output by the first terminal submodel. For example, the terminal gradient includes a parameter gradient of the first terminal submodel and a cloud output gradient, and the cloud output gradient may be a gradient of the cloud output.

In step S204, the terminal gradient is outputted to the server. After the terminal gradient output by the first terminal submodel is outputted to the server, the server may calculate and obtain a parameter gradient of the cloud submodel based on the terminal gradient output by the first terminal submodel and the cloud output, and adjust the current parameter of the first terminal submodel and the current parameter of the cloud submodel by using the parameter gradient of the first terminal submodel and the parameter gradient of the cloud submodel, respectively.

Steps S200 and S203 to S204 represent a forward propagation process and a backward propagation process of the first terminal submodel.

The model training method provided in the embodiments of the present disclosure splits the machine learning model into the cloud submodel and the terminal submodel, to implement federated machine learning between the server and the terminal, implement user privacy and data security protection, and solve a problem that a model on a terminal such as an in-vehicle infotainment device is too large to be trained. A structure of the terminal submodel run on the terminal is relatively small, so that the terminal submodel can be adapted to a terminal with a small computing power, and the federated machine learning can be applied to the terminal with the small computing power, thereby further expanding the application scope and application scenarios of the federated machine learning, and effectively helping a plurality of terminals to use data and perform machine learning modeling while meeting requirements of user privacy protection and data security. In addition, since a plurality of terminals are combined for federated training, accuracy and precision of the machine learning model obtained through training can be improved.

For example, the first terminal may store a training sample set for training the first terminal submodel, the training sample set includes a plurality of terminal training samples, and each terminal training sample includes a terminal training feature and a sample label. The terminal training sample may be preset based on experience, or may be generated in real time as the terminal is used. For example, in some embodiments, the first terminal may be an in-vehicle air conditioner. At a specific moment, the first terminal needs to control an in-vehicle temperature of a motor vehicle to which the in-vehicle air conditioner belongs, and in this case, the first terminal generates one terminal training feature. The terminal training feature may include information such as a current in-vehicle temperature and a current number of in-vehicle persons of the motor vehicle. A corresponding cloud training feature is generated by the server corresponding to the terminal training feature. In this case, the machine learning model may process the terminal training feature and the cloud training feature to obtain a predicted temperature, and then the in-vehicle air conditioner may be adjusted to the predicted temperature. Then, when a person in the vehicle sends a feedback message, the feedback message is the sample label corresponding to the terminal training feature, and the feedback message may be that the temperature is not appropriate (the temperature is too high or too low) or the temperature is appropriate. Based on the predicted temperature and the feedback message, a gradient may be generated to adjust a parameter of the machine learning model. The terminal training feature and the sample label are one terminal training sample, and a training progress identifier corresponding to the terminal training sample may be a timestamp corresponding to a moment when the terminal training feature is generated or a number accumulated on the first terminal.

It should be noted that when a person in the vehicle does not send the feedback message, it may be defaulted that a currently predicted result of the machine learning model meets an expected result of a user. For example, in the foregoing example, when the person in the vehicle does not send the feedback message, the sample label corresponding to the terminal training feature is that the predicted temperature is appropriate. In addition, specific information of the terminal training feature may be set according to an actual situation, which is not specifically limited in the present disclosure.

For example, in some embodiments, step S200 may include: sending a training progress query request to the server; receiving, from the server, stored training progress information corresponding to the first terminal submodel; performing a sample screening operation based on the stored training progress information; and in response to the sample screening operation obtaining K terminal training samples, obtaining the at least one terminal training sample based on the K terminal training samples. For example, K is a positive integer. For example, the first terminal may perform the sample screening operation on the training sample set corresponding to the first terminal submodel based on the stored training progress information, to obtain the K terminal training samples for training the first terminal submodel, and then select the at least one terminal training sample from the K terminal training samples. When the first terminal submodel is set with a corresponding terminal sample threshold, a number of the at least one terminal training sample is less than or equal to the terminal sample threshold. For example, when K is less than or equal to the terminal sample threshold, the K terminal training samples may be selected for model training; and when K is greater than the terminal sample threshold, some terminal training samples in the K terminal training samples may be selected for model training. When the sample screening operation does not obtain the terminal training sample, the model training is not performed.

For example, in some embodiments, in step S201, after obtaining the at least one terminal training sample, the first terminal may send a training request to the server based on the at least one terminal training sample. The training request sent by the first terminal includes identification information of the first terminal, a sample identifier list, or the like. The sample identifier list is used to indicate at least one sample identifier respectively corresponding to the at least one terminal training sample. Then, the server obtains the at least one sub-cloud training feature respectively corresponding to the at least one terminal training sample based on the training request sent by the first terminal for training, to obtain the at least one sub-cloud output corresponding to the at least one terminal training sample. In addition, the server also obtains a current parameter of the first terminal submodel. Then, the server outputs the at least one sub-cloud output corresponding to the at least one terminal training sample and the current parameter of the first terminal submodel to the first terminal.

For example, in some embodiments, step S203 may include: for each of the at least one terminal training sample: processing, by using the first terminal submodel with the current parameters, the sub-cloud output corresponding to the terminal training sample and the terminal training feature in the terminal training sample to obtain an output of the first terminal submodel; obtaining a loss value of the first terminal submodel based on the output of the first terminal submodel and the sample label in the terminal training sample; and obtaining the terminal gradient based on the loss value and the output of the first terminal submodel.

For example, in some embodiments, the model training method further includes: determining current training progress information corresponding to the first terminal submodel based on the at least one terminal training sample; and sending the current training progress information to the server, for the server to update the stored training progress information corresponding to the first terminal submodel to the current training progress information.

It should be noted that for specific operations performed by the server, refer to the description in the foregoing embodiments of the model training method applied to the server. Details of the same parts are not repeated.

FIG. 5 is a schematic diagram of a model training system according to at least one embodiment of the present disclosure.

At least one embodiment of the present disclosure further provides a model training system. The model training system is configured to train a machine learning model. The machine learning model includes a cloud submodel and M terminal submodels, and M is a positive integer. As shown in FIG. 5, the model training system 1100 may include at least one terminal 1101 and a server 1102, the cloud submodel is run on the server 1102, and the M terminal submodels are run on the at least one terminal 1101.

For example, the server 1102 is configured to: obtain a cloud training feature; train the cloud submodel by using the cloud training feature to obtain a cloud output result of the cloud submodel; send the cloud output result and current parameters of the M terminal submodels to the at least one terminal; receive terminal gradients respectively output by N terminal submodels in the M terminal submodels that are output by the at least one terminal, where N is a positive integer and less than or equal to M, and a terminal gradient output by each of the N terminal submodels includes a parameter gradient of the terminal submodel and a cloud output gradient; calculate and obtain a parameter gradient of the cloud submodel based on the terminal gradients respectively output by the N terminal submodels and the cloud output result; and adjust current parameters of the N terminal submodels and a current parameter of the cloud submodel by using the parameter gradients of the N terminal submodels and the parameter gradient of the cloud submodel.

Each of the at least one terminal 1101 is configured to: obtain at least one terminal training sample, where each terminal training sample includes a terminal training feature and a sample label, and the cloud training feature includes at least one sub-cloud training feature in a one-to-one correspondence with the at least one terminal training sample; receive, from the server 1102, at least one cloud output corresponding to the at least one terminal training sample and a current parameter of a terminal submodel run on the terminal, where the cloud output result includes the at least one cloud output; train the terminal submodel run on the terminal by using the at least one cloud output, the current parameter of the terminal submodel run on the terminal, and the at least one terminal training sample to obtain a terminal gradient output by the terminal submodel run on the terminal; and output the terminal gradient output by the terminal submodel run on the terminal to the server 1102.

The server 1102 may be configured to implement the model training method shown in FIG. 2, and each of the at least one terminal 1101 may be configured to implement the model training method shown in FIG. 4. For specific operations that can be implemented by the server 1102 and the terminal 1101, refer to the foregoing embodiments of the model training method. Details of the same parts are not repeated.

The following briefly describes an overall process of federated training performed by one server and one terminal in the model training system.

The terminal periodically checks whether a training condition is met. The training condition includes information such as a sample size and a network environment. If the training condition is met, the terminal discovers a training progress query request to the server to query whether training can be performed. The training progress query request includes identification information of the terminal. When the server receives the training progress query request from the terminal, the server searches for a model being trained, and finds stored training progress information of a terminal submodel run on the terminal based on the identification information of the terminal. Then, the server returns a name of the terminal submodel and the stored training progress information to the corresponding terminal. After receiving the name of the terminal submodel and the stored training progress information that are sent by the server, the terminal searches for all terminal training samples that can be trained in a local training sample set. If the terminal finds the terminal training samples that can be trained, the terminal sends the name of the terminal submodel and a sample identifier list to the server. The sample identifier list may include sample identifiers of the terminal training samples.

After receiving the name of the terminal submodel and the sample identifier list from the terminal, the server searches for, in a sample library at the server based on the sample identifier list, cloud training samples corresponding to the terminal training samples indicated by the sample identifiers in the sample identifier list. Each cloud training sample includes a cloud training feature. Then, the server obtains a current parameter of the cloud submodel through a parameter module, inputs the cloud training features into the cloud submodel to obtain an output of the cloud submodel (if combined training is required, it is necessary to wait for another terminal to report terminal training samples, and then input all the combined cloud training features into the cloud submodel together). In addition, the server obtains a current parameter of the terminal submodel through the parameter module. Finally, the server returns the output of the cloud submodel and the current parameter of the terminal submodel to the terminal, and generates and returns a chat identifier.

After receiving the output of the cloud submodel and the current parameter of the terminal submodel, the terminal inputs the terminal training feature of the terminal training sample and the output of the cloud submodel into the terminal submodel to obtain an output of the terminal submodel (namely, a prediction result), and then obtains a loss value of the output of the terminal submodel based on the output of the terminal submodel and the sample label of the terminal training sample. A gradient is calculated based on the loss value, that is, the terminal gradient output by the terminal submodel is obtained through back propagation (including a parameter gradient of the terminal submodel and a cloud output gradient). Finally, the terminal returns the terminal gradient output by the terminal submodel to the server, and brings the previous chat identifier.

After receiving the terminal gradient output by the terminal submodel, the server continues to perform back propagation through the cloud output gradient to obtain a parameter gradient of the cloud submodel (if combined training is required, it is necessary to wait for another terminal to report a terminal gradient, and then perform back propagation). In this way, the server obtains the parameter gradient of the cloud submodel and the parameter gradient of the terminal submodel, that is, a gradient of the entire machine learning model. Then, the server submits the parameter gradient of the cloud submodel and the parameter gradient of the terminal submodel to a parameter server to update parameters of the machine learning model, and updates the stored training progress information corresponding to the terminal submodel (the stored training progress information is also stored in the parameter server).

After the terminal sends the gradient to the server, it may be considered that one round of training is completed, and the next training is awaited.

FIG. 6 is a schematic diagram of an overall process of model training performed by a model training system according to at least one embodiment of the present disclosure. For example, the model training system may be the model training system as shown in FIG. 5.

In the embodiments of the present disclosure, the overall process of model training performed by the model training system includes three parts: forward propagation of a cloud submodel, forward propagation and backward propagation of a terminal submodel, and backward propagation of the cloud submodel.

In an example, the machine learning model may include one cloud submodel and one terminal submodel. As shown in FIG. 6, the cloud submodel may include a first layer layer1 and a second layer layer2, the terminal submodel may include a third layer layer3, and each of the first layer layer1, the second layer layer2, and the third layer layer3 may be a convolutional layer, a fully connected layer, a pooling layer, or the like. The cloud submodel is run on the server, and the terminal submodel is run on the terminal. The cloud submodel and the terminal submodel shown in FIG. 6 are merely schematic. The cloud submodel may include more layers, and the terminal submodel may also include more layers.

In the forward propagation of the cloud submodel, the server inputs the cloud training feature into the cloud submodel to obtain a forward propagation result of the cloud submodel (namely, the foregoing cloud output result), and then sends the forward propagation result and a current parameter of the terminal submodel to the terminal. As shown in FIG. 6, the first layer layer1 of the cloud submodel processes the cloud training feature to obtain an output O1 of the first layer layer1, and the second layer layer2 of the cloud submodel processes the output O1 of the first layer layer to obtain an output O2 of the second layer layer2. The output O2 of the second layer layer2 may represent the cloud output result of the cloud submodel. Then, the server sends the cloud output result and the current parameter of the terminal submodel to the terminal on which the terminal submodel is run.

In the forward propagation and backward propagation of the terminal submodel, the terminal receives the cloud output result of the cloud submodel and the current parameter of the terminal submodel, and inputs the cloud output result, terminal input “In” (including a terminal training feature) of the terminal, and a sample label into the terminal submodel together for forward propagation and backward propagation, to obtain a terminal gradient output by the terminal submodel. Then, the terminal sends the terminal gradient to the server. As shown in FIG. 6, the third layer layer3 of the terminal submodel processes the cloud output result (namely, the output O2 of the second layer layer2) and the terminal input “In” to obtain an output O3 of the third layer layer3. The output O3 of the third layer layer3 is a prediction result of the machine learning model. Then, a loss value of the machine learning model is calculated by using a loss function based on the prediction result and the sample label. A parameter gradient GL3 (namely, a gradient of a parameter of the third layer layer3) of the terminal submodel and a cloud output gradient GO of the terminal submodel are calculated based on the loss value and the output O3 of the third layer layer3. Finally, the parameter gradient GL3 of the terminal submodel and the cloud output gradient GO of the terminal submodel are transmitted to the server.

In the backward propagation of the cloud submodel, after receiving the parameter gradient and the cloud output gradient of the terminal submodel, the server performs a backward propagation process of the cloud submodel to obtain a parameter gradient of the cloud submodel. Finally, the parameters of the machine learning model are updated by using a parameter optimizer to complete one round of training. As shown in FIG. 6, in the backward propagation of the cloud submodel, first, a parameter gradient GL2 of the second layer layer2 is calculated based on the cloud output gradient GO of the terminal submodel and the output O2 of the second layer layer2. Then, a parameter gradient GL1 of the first layer layer1 is calculated based on the parameter gradient GL2 of the second layer layer2 and the output O1 of the first layer layer1. The parameter gradient of the cloud submodel includes the parameter gradient GL1 of the first layer layer1 and the parameter gradient GL2 of the second layer layer2. Finally, the parameter optimizer updates a parameter of the terminal submodel (the third layer layer3) based on the parameter gradient GL3 of the terminal submodel, and updates a parameter of the cloud submodel (the first layer layer1 and the second layer layer2) based on the parameter gradient GL1 of the first layer layer1 and the parameter gradient GL2 of the second layer layer2.

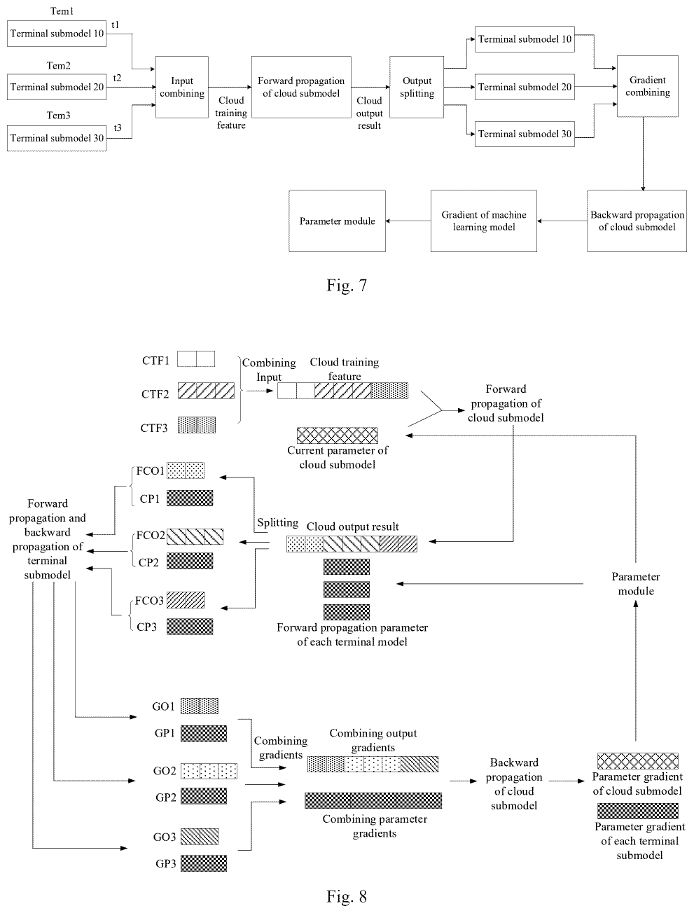

FIG. 7 is an example diagram of a specific training process of model training performed by a model training system according to some embodiments of the present disclosure, and FIG. 8 is an example diagram of a specific training process of model training performed by a model training system according to some embodiments of the present disclosure. FIG. 7 and FIG. 8 illustrate a process of combined training performed on a plurality of terminals, and FIG. 7 and FIG. 8 are described by using three terminals as an example. The following describes the overall process of model training performed by the model training system in detail with reference to FIG. 7 and FIG. 8.

As shown in FIG. 7, the at least one terminal includes a terminal Tem1, a terminal Tem2, and a terminal Tem3, and the M terminal submodels include a terminal submodel 10 run on the terminal Tem1, a terminal submodel 20 run on the terminal Tem2, and a terminal submodel 30 run on the terminal Tem3.

As shown in FIG. 7 and FIG. 8, at a moment t1, the server receives a training request sent by the terminal Tem1, and then obtains at least one sub-cloud training feature CTF1 corresponding to the terminal Tem1 based on the training request sent by the terminal Tem1. FIG. 8 shows two sub-cloud training features CTF1 (each rectangular box represents one sub-cloud training feature). At a moment t2, the server receives a training request sent by the terminal Tem2, and then obtains at least one sub-cloud training feature CTF2 corresponding to the terminal Tem2 based on the training request sent by the terminal Tem2. FIG. 8 shows three sub-cloud training features CTF2. At a moment t3, the server receives a training request sent by the terminal Tem3, and then obtains at least one sub-cloud training feature CTF3 corresponding to the terminal Tem3 based on the training request sent by the terminal Tem3. FIG. 8 shows two sub-cloud training features CTF3. Then, input combining is performed, that is, input combining processing is performed on the at least one sub-cloud training feature CTF1 corresponding to the terminal Tem1, the at least one sub-cloud training feature CTF2 corresponding to the terminal Tem2, and the at least one sub-cloud training feature CTF3 corresponding to the terminal Tem3 to obtain the cloud training feature.

For example, an absolute value of a time difference between any two of the moment t1, the moment t2, and the moment t3 is within a preset time difference range. In an example, the moment t1, the moment t2, and the moment t3 may be a same moment.

As shown in FIG. 7 and FIG. 8, after the cloud training feature is obtained, a current parameter of the cloud submodel may be obtained from the parameter module. Then, forward propagation of the cloud submodel is performed based on the cloud training feature and the current parameter of the cloud submodel, to obtain the cloud output result. Then, an output splitting operation is performed on the cloud output result to obtain a cloud output FCO1 corresponding to the terminal submodel 10, a cloud output FCO2 corresponding to the terminal submodel 20, and a cloud output FCO3 corresponding to the terminal submodel 30. In addition, a current parameter of the terminal submodels may be obtained from the parameter module. Then, the cloud output FCO1 and current parameters CP1 of the terminal submodel 10 are transmitted to the terminal Tem1, so that the terminal Tem1 performs forward propagation and backward propagation of the terminal submodel 10 to obtain a parameter gradient GP1 of the terminal submodel 10 and a cloud output gradient GO1 of the terminal submodel 10. The cloud output FCO2 and current parameters CP2 of the terminal submodel 20 are transmitted to the terminal Tem2, so that the terminal Tem2 performs forward propagation and backward propagation of the terminal submodel 20 to obtain a parameter gradient GP2 of the terminal submodel 20 and a cloud output gradient GO2 of the terminal submodel 20. The cloud output FCO3 and current parameters CP3 of the terminal submodel 30 are transmitted to the terminal Tem3, so that the terminal Tem3 performs forward propagation and backward propagation of the terminal submodel 30 to obtain a parameter gradient GP3 of the terminal submodel 30 and a cloud output gradient GO3 of the terminal submodel 30.

As shown in FIG. 7 and FIG. 8, the terminal Tem1 may transmit the parameter gradient GP1 of the terminal submodel 10 and the cloud output gradient GO1 of the terminal submodel 10 to the server, the terminal Tem2 may transmit the parameter gradient GP2 of the terminal submodel 20 and the cloud output gradient GO2 of the terminal submodel 20 to the server, and the terminal Tem3 may transmit the parameter gradient GP3 of the terminal submodel 30 and the cloud output gradient GO3 of the terminal submodel 30 to the server. After receiving the gradients transmitted by the terminals, the server may perform gradient combining. For example, the server may combine the parameter gradient GP1 of the terminal submodel 10, the parameter gradient GP2 of the terminal submodel 20, and the parameter gradient GP3 of the terminal submodel 30 to obtain a combined parameter gradient; and combine the cloud output gradient GO1 of the terminal submodel 10, the cloud output gradient GO2 of the terminal submodel 20, and the cloud output gradient GO3 of the terminal submodel 30 to obtain a combined output gradient.

As shown in FIG. 7 and FIG. 8, after the combined output gradient is obtained, backward propagation of the cloud submodel may be performed to obtain the parameter gradient of the cloud submodel. The gradient of the machine learning model may include the parameter gradient of the cloud submodel and the parameter gradients of the terminal submodels (namely, GP1 to GP3, the combined parameter gradient). Then, the parameter module may include a parameter optimizer. The parameter optimizer may receive the combined parameter gradient and the parameter gradient of the cloud submodel, and then adjust a parameter of the cloud submodel based on the parameter gradient of the cloud submodel to update the parameter of the cloud submodel; and adjust parameters of the terminal submodel 10, the terminal submodel 20, and the terminal submodel 30 based on the combined parameter gradient to update the parameter of the terminal submodel 10, the parameter of the terminal submodel 20, and the parameter of the terminal submodel 30. In this way, one round of model training is completed.

It should be noted that in some other embodiments, the parameter gradients of the terminal submodels may not be combined. Instead, the parameter gradients of the terminal submodels are directly input to the parameter optimizer, and the parameter optimizer adjusts the parameters of the terminal submodels respectively based on the parameter gradients of the terminal submodels. For example, in this case, the parameter optimizer may adjust the parameter of the terminal submodel 10 based on the parameter gradient GP1 of the terminal submodel 10 to update the parameter of the terminal submodel 10; adjust the parameter of the terminal submodel 20 based on the parameter gradient GP2 of the terminal submodel 20 to update the parameter of the terminal submodel 20; and adjust the parameter of the terminal submodel 30 based on the parameter gradient GP3 of the terminal submodel 30 to update the parameter of the terminal submodel 30.

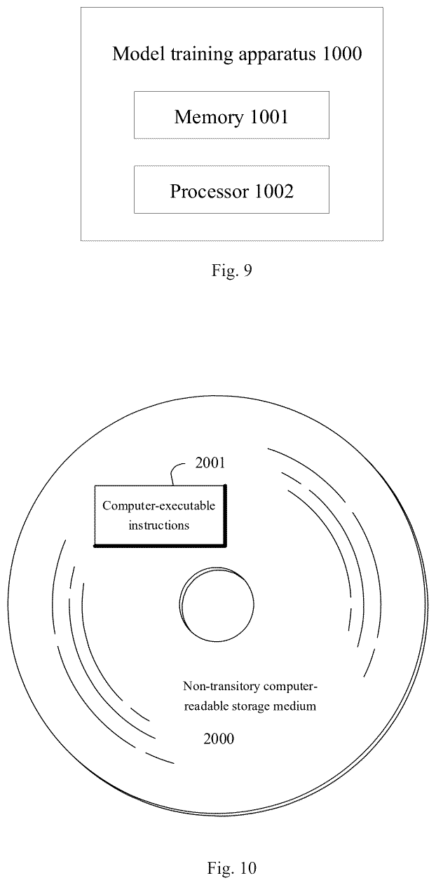

FIG. 9 is a schematic block diagram of a model training apparatus according to at least one embodiment of the present disclosure.

At least one embodiment of the present disclosure further provides a model training apparatus. As shown in FIG. 9, the model training apparatus 1000 may include one or more memories 1001 and one or more processors 1002. It should be noted that components of the model training apparatus 1000 are merely exemplary and not restrictive. According to actual application requirements, the model training apparatus 1000 may further include other components, which is not specifically limited in the embodiments of the present disclosure.

For example, the one or more memories 1001 are configured to non-transitorily store computer-executable instructions; and the one or more processors 1002 are configured to run the computer-executable instructions. The computer-executable instructions, when run on the one or more processors 1002, implement one or more steps in the model training method according to any one of the embodiments of the present disclosure. For example, the model training apparatus 1000 may be used for the model training method shown in FIG. 2 and/or the model training method shown in FIG. 4.

For a specific implementation and related explanation content of each step of the model training method, refer to the foregoing embodiments of the model training method. Details of the same parts are not repeated.

For example, the memory 1001 and the processor 1002 may directly or indirectly communicate with each other. For example, in some embodiments, the model training apparatus 1000 may further include a communication interface and a communication bus. The memory 1001, the processor 1002, and the communication interface may communicate with each other through the communication bus, and components such as the memory 1001, the processor 1002, and the communication interface may also communicate through a network connection. The network may include a wireless network, a wired network, and/or any combination of the wireless network and the wired network. The present disclosure does not limit a type and a function of the network.

For example, the communication bus may be a peripheral component interconnect standard (PCI) bus, an extended industry standard architecture (EISA) bus, or the like. The communication bus may be classified into an address bus, a data bus, a control bus, and the like.

For example, the communication interface is configured to implement communication between the model training apparatus 1000 and another device. The communication interface may be a universal serial bus (USB) interface or the like.

For example, the memory 1001 and the processor 1002 may be disposed at a server (or a cloud).

For example, the processor 1002 may control another component in the model training apparatus to perform an expected function. The processor may be a central processing unit (CPU), a graphics processing unit (GPU), a network processor (NP), or the like. Alternatively, the processor may be another form of processing unit with a model training capability and/or a program execution capability, for example, a digital signal processor (DSP), an application-specific integrated circuit (ASIC), a field programmable gate array (FPGA), a tensor processing unit (TPU), or another programmable logic device, a discrete gate or transistor logic device, or a discrete hardware component. The central processing unit (CPU) may be an X86 architecture, an ARM architecture, or the like.

For example, the memory 1001 may be a computer-readable medium, and may include any combination of one or more computer program products, and the computer program product may include various forms of computer-readable storage media, for example, a volatile memory and/or a non-volatile memory. The volatile memory may include, for example, a random access memory (RAM) and/or a cache. The non-volatile memory may include, for example, a read-only memory (ROM), a hard disk, an erasable programmable read-only memory (EPROM), a portable compact disc read-only memory (CD-ROM), a USB memory, a flash memory, or the like. One or more computer-readable instructions may be stored on the computer-readable storage medium, and the processor may run the computer-readable instructions to implement various functions of the model training apparatus 1000. Various applications, various data, and the like may further be stored in the storage medium.

For a technical effect that can be implemented by the model training apparatus, refer to the related description in the foregoing embodiments of the model training method. Details of the same parts will not be repeated.

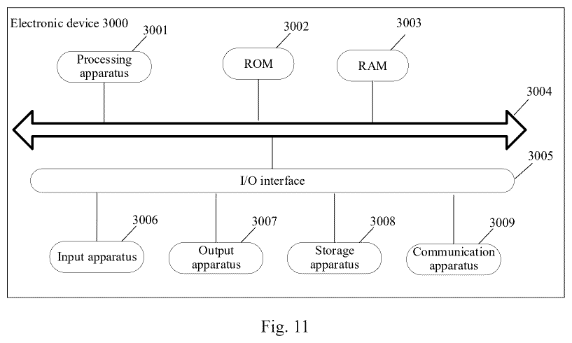

FIG. 10 is a schematic diagram of a non-transitory computer-readable storage medium according to at least one embodiment of the present disclosure. For example, as shown in FIG. 10, one or more computer-executable instructions 2001 may be stored in the non-transitory computer-readable storage medium 2000 in a non-transitory manner. For example, when the computer-executable instructions 2001 are executed by a processor, one or more steps in the model training method according to any one of the embodiments of the present disclosure may be performed.

For example, the non-transitory computer-readable storage medium 2000 may be applied to the model training apparatus 1000. For example, the non-transitory computer-readable storage medium 2000 may include the memory 1001 in the model training apparatus 1000.

For example, for the description of the non-transitory computer-readable storage medium 2000, the description of the memory 1001 in the embodiment of the model training apparatus 1000 may be referred. Details of the same parts are not repeated.

Reference is made to FIG. 11. FIG. 11 is a schematic diagram of a structure of an electronic device 3000 suitable for implementing the embodiments of the present disclosure. The electronic device 3000 may be a terminal (for example, a computer) or a processor, and may be configured to perform the model training method in the foregoing embodiments. The electronic device in the embodiments of the present disclosure may include but is not limited to mobile terminals such as a mobile phone, a notebook computer, a digital broadcast receiver, a personal digital assistant (PDA for short), a portable android device (PAD for short), a portable media player (PMP for short), and a vehicle-mounted terminal (for example, a vehicle navigation terminal), a wearable electronic devices, and the like, and may include but is not limited to fixed terminals such as a TV and a desktop computer, and a smart home device, and the like. The electronic device shown in FIG. 11 is merely an example, and shall not impose any limitation on a function and a scope of use of the embodiments of the present disclosure.

As shown in FIG. 11, the electronic device 3000 may include a processing apparatus (for example, a central processor, a graphics processor, or the like) 3001 that may perform a variety of appropriate actions and processing in accordance with a program stored in a read-only memory (ROM) 3002 or a program loaded from a storage apparatus 3008 into a random access memory (RAM) 3003. The RAM 3003 further stores various programs and data required for the operation of the electronic device 3000. The processing apparatus 3001, the ROM 3002, and the RAM 3003 are connected to each other through a bus 3004. An input/output (I/O) interface 3005 is also connected to the bus 3004.

Generally, the following apparatuses may be connected to the I/O interface 3005: an input apparatus 3006 including, for example, a touch screen, a touchpad, a keyboard, a mouse, a camera, a microphone, an accelerometer, a gyroscope, and the like; an output apparatus 3007 including, for example, a liquid crystal display (LCD), a speaker, and a vibrator, and the like; the storage apparatus 3008 including, for example, a tape and a hard disk, and the like; and a communication apparatus 3009. The communication apparatus 3009 may allow the electronic device 3000 to perform wireless or wired communication with other devices to exchange data. Although FIG. 11 shows the electronic device 3000 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart, to perform one or more steps in the model training method described above. In such an embodiment, the computer program may be downloaded from a network through the communication apparatus 3009 and installed, installed from the storage apparatus 3008, or installed from the ROM 3002. When the computer program is executed by the processing apparatus 3001, the processing apparatus 3001 may be enabled to perform the above functions defined in the model training method of this embodiment of the present disclosure.

It should be noted that, in the context of the present disclosure, the computer-readable medium may be a tangible medium that may contain or store a program used by or in combination with an instruction execution system, apparatus, or device. The computer-readable medium may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that can be used by or in combination with an instruction execution system, apparatus, or device. In the present disclosure, the computer-readable signal medium may include a data signal propagated in a baseband or as a part of a carrier, where the data signal carries computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination of the foregoing media.

The foregoing computer-readable medium may be contained in the foregoing electronic device. Alternatively, the computer-readable medium may exist independently, without being assembled into the electronic device.

The computer program code for performing the operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partly executed on a computer of a user, executed as an independent software package, partly executed on a computer of a user and partly executed on a remote computer, or completely executed on a remote computer or server. In the case involving a remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession can actually be performed substantially in parallel, or they can sometimes be performed in the reverse order, depending on a function involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. For example, the name of a unit does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

It may be understood that before the technical solutions disclosed in the embodiments of the present disclosure are used, the user shall be informed of the types, scope of use, and usage scenarios of the personal information involved in the present disclosure and the user's authorization shall be obtained through an appropriate manner in accordance with relevant laws and regulations.

For example, when a user actively requests, prompt information is sent to the user to explicitly prompt the user that an operation requested by the user will need to acquire and use the user information of the user. Therefore, the user can selectively provide the user information to software or hardware, such as an electronic device, an application, a server, or a storage medium, that executes the operation of the technical solutions of the present disclosure according to the prompt information.

As an optional but non-restrictive implementation, a manner of sending the prompt information to the user in response to receiving the active request from the user may be, for example, a pop-up window, and the prompt information may be presented in the pop-up window in a text manner. In addition, the pop-up window may further carry a selection control for the user to select “agree” or “disagree” to provide the user information to the electronic device.

It may be understood that the foregoing process of notification and obtaining the user authorization is merely illustrative, and does not constitute a limitation on the implementation of the present disclosure. Other manners that comply with relevant laws, regulations, and related provisions may also be applied to the implementation of the present disclosure.

It may be understood that data (including but not limited to the data itself, the acquisition or use of the data) involved in the technical solution of the present disclosure shall comply with requirements of corresponding laws, regulations, and related provisions.

In a first aspect, according to one or more embodiments of the present disclosure, a model training method is provided, where the model training method is applied to a server and is configured to train a machine learning model, the machine learning model includes a cloud submodel and M terminal submodels, the cloud submodel is run on the server, the M terminal submodels are run on at least one terminal, M is a positive integer, and the model training method includes: obtaining a cloud training feature; training the cloud submodel by using the cloud training feature to obtain a cloud output result of the cloud submodel; sending the cloud output result and current parameters of the M terminal submodels to the at least one terminal; receiving terminal gradients respectively output by N terminal submodels in the M terminal submodels that are output by the at least one terminal, where N is a positive integer and less than or equal to M, and a terminal gradient output by each of the N terminal submodels includes a parameter gradient of the terminal submodel and a cloud output gradient; calculating and obtaining a parameter gradient of the cloud submodel based on the terminal gradients respectively output by the N terminal submodels and the cloud output result; and adjusting current parameters of the N terminal submodels and a current parameter of the cloud submodel by using the parameter gradients of the N terminal submodels and the parameter gradient of the cloud submodel.

According to one or more embodiments of the present disclosure, the M terminal submodels are in a one-to-one correspondence with M pieces of stored training progress information, respectively, and the M pieces of stored training progress information are stored in the server.

According to one or more embodiments of the present disclosure, the model training method further includes: for each of the at least one terminal: receiving, from the terminal, current training progress information of each terminal submodel that is run on the terminal; and adjusting the stored training progress information corresponding to each terminal submodel based on the current training progress information.

According to one or more embodiments of the present disclosure, each terminal stores a training sample set for training all terminal submodels that are run on the terminal, the training sample set includes a plurality of terminal training samples, each terminal training sample includes a terminal training feature and a sample label, the terminal training features in the plurality of terminal training samples are sequentially generated in order, and each terminal training sample has a corresponding training progress identifier, and the current training progress information of each terminal submodel represents a training progress identifier of a last generated terminal training sample in all terminal training samples that is used for training each terminal submodel in the training sample set.

According to one or more embodiments of the present disclosure, the at least one terminal includes a first terminal, and the obtaining the cloud training feature includes: receiving a training request sent by the first terminal, where the training request sent by the first terminal includes identification information of the first terminal; and obtaining at least one first sub-cloud training feature based on the training request sent by the first terminal, where the cloud training feature includes the at least one first sub-cloud training feature.

According to one or more embodiments of the present disclosure, the at least one terminal further includes a second terminal, and obtaining the cloud training feature further includes: receiving a training request sent by the second terminal, where the training request sent by the second terminal includes identification information of the second terminal; obtaining at least one second sub-cloud training feature based on the training request sent by the second terminal; and performing combining processing on the at least one first sub-cloud training feature and the at least one second sub-cloud training feature to obtain the cloud training feature.

According to one or more embodiments of the present disclosure, an absolute value of a time difference between a moment when the training request is sent by the first terminal and a moment when the training request is sent by the second terminal is within a time difference range.

According to one or more embodiments of the present disclosure, M is greater than 1, the M terminal submodels include a first terminal submodel and a second terminal submodel, the at least one terminal includes a first terminal and a second terminal, the first terminal submodel is run on the first terminal, the second terminal submodel is run on the second terminal, and the sending the cloud output result and the current parameters of the M terminal submodels to the at least one terminal includes: performing splitting processing on the cloud output result to obtain a first cloud output corresponding to the first terminal submodel and a second cloud output corresponding to the second terminal submodel; obtaining a current parameter of the first terminal submodel and a current parameter of the second terminal submodel; transmitting the first cloud output and the current parameter of the first terminal submodel to the first terminal; and transmitting the second cloud output and the current parameter of the second terminal submodel to the second terminal.

According to one or more embodiments of the present disclosure, the M terminal submodels include a first terminal submodel and a third terminal submodel, the at least one terminal includes a first terminal, both the first terminal submodel and the third terminal submodel are run on the first terminal, and the sending the cloud output result and the current parameters of the M terminal submodels to the at least one terminal includes: performing splitting processing on the cloud output result to obtain a first cloud output corresponding to the first terminal submodel and a third cloud output corresponding to the third terminal submodel; obtaining a current parameter of the first terminal submodel and a current parameter of the third terminal submodel; and transmitting the first cloud output, the third cloud output, the current parameter of the first terminal submodel, and the current parameter of the third terminal submodel to the first terminal.

According to one or more embodiments of the present disclosure, the training the cloud submodel by using the cloud training feature to obtain the cloud output result of the cloud submodel includes: obtaining a current parameter of the cloud submodel, where the current parameter of the cloud submodel represents a parameter of the cloud submodel when obtaining the cloud training feature; and training the cloud submodel with the current parameter of the cloud submodel by using the cloud training feature to obtain the cloud output result of the cloud submodel.

According to one or more embodiments of the present disclosure, M is greater than 1, N is greater than 1, and calculating and obtaining the parameter gradient of the cloud submodel based on the terminal gradients respectively output by the N terminal submodels and the cloud output result includes: performing combining processing on cloud output gradients of the N terminal submodels to obtain a combined output gradient; and calculating and obtaining the parameter gradient of the cloud submodel based on the combined output gradient and the cloud output result.

According to one or more embodiments of the present disclosure, inputs of the M terminal submodels match an output of the cloud submodel.

According to one or more embodiments of the present disclosure, the model training method further includes: receiving a training progress query request sent by each terminal, the training progress query request corresponds to a terminal submodel run on the corresponding terminal; obtaining stored training progress information corresponding to the terminal submodel based on the training progress query request; and outputting the stored training progress information to the corresponding terminal, for the corresponding terminal to perform a sample screening operation based on the stored training progress information, where in response to obtaining at least one terminal training sample through the sample screening operation, the corresponding terminal sends a training request to the server to perform model training.

In a second aspect, according to one or more embodiments of the present disclosure, a model training method is provided, where the model training method is applied to a first terminal and is configured to train a machine learning model, the machine learning model includes a cloud submodel and a first terminal submodel, the cloud submodel is run on a server, the first terminal submodel is run on the first terminal, and the model training method includes: obtaining at least one terminal training sample, where each terminal training sample includes a terminal training feature and a sample label; sending a training request to the server based on the at least one terminal training sample; receiving, from the server, a cloud output corresponding to the at least one terminal training sample and a current parameter of the first terminal submodel; training the first terminal submodel by using the cloud output, the current parameter of the first terminal submodel, and the at least one terminal training sample to obtain a terminal gradient output by the first terminal submodel, where the terminal gradient includes a parameter gradient of the first terminal submodel and a cloud output gradient; and outputting the terminal gradient to the server, for the server to calculate and obtain a parameter gradient of the cloud submodel based on the terminal gradient and the cloud output, and to adjust the current parameter of the first terminal submodel and a current parameter of the cloud submodel by using the parameter gradient of the first terminal submodel and the parameter gradient of the cloud submodel.

According to one or more embodiments of the present disclosure, the obtaining the at least one terminal training sample includes: sending a training progress query request to the server; receiving, from the server, stored training progress information corresponding to the first terminal submodel; performing a sample screening operation based on the stored training progress information; and obtaining the at least one terminal training sample based on K terminal training samples obtained by the sample screening operation, where K is a positive integer.

According to one or more embodiments of the present disclosure, the model training method further includes: determining current training progress information corresponding to the first terminal submodel based on the at least one terminal training sample; and sending the current training progress information to the server, for the server to update the stored training progress information corresponding to the first terminal submodel to the current training progress information.

According to one or more embodiments of the present disclosure, the cloud output includes at least one sub-cloud output in a one-to-one correspondence with the at least one terminal training sample, and the training the first terminal submodel by using the cloud output, the current parameter of the first terminal submodel, and the at least one terminal training sample to obtain the terminal gradient output by the first terminal submodel includes: for each terminal training sample of the at least one terminal training sample: processing a sub-cloud output corresponding to the terminal training sample and a terminal training feature in the terminal training sample by using the first terminal submodel with the current parameter of the first terminal submodel to obtain an output of the first terminal submodel; obtaining a loss value of the first terminal submodel based on the output of the first terminal submodel and a sample label in the terminal training sample; and obtaining the terminal gradient based on the loss value and the output of the first terminal submodel.

In a third aspect, according to one or more embodiments of the present disclosure, a model training apparatus is provided, and includes: one or more memories configured to non-transitorily store computer-executable instructions; and one or more processors configured to run the computer-executable instructions, where the computer-executable instructions, when run on the one or more processors, implement the model training method according to any one of the embodiments of the present disclosure.

In a fourth aspect, according to one or more embodiments of the present disclosure, a model training system is provided, where the model training system is configured to train a machine learning model and includes at least one terminal and a server. The machine learning model includes a cloud submodel and M terminal submodels, the cloud submodel is run on the server, the M terminal submodels are run on the at least one terminal, M is a positive integer, and the server is configured to: obtain a cloud training feature; train the cloud submodel by using the cloud training feature to obtain a cloud output result of the cloud submodel; send the cloud output result and current parameters of the M terminal submodels to the at least one terminal; receive terminal gradients respectively output by N terminal submodels in the M terminal submodels that are output by the at least one terminal, where N is a positive integer and less than or equal to M, and a terminal gradient output by each of the N terminal submodels includes a parameter gradient of the terminal submodel and a cloud output gradient; calculate and obtain a parameter gradient of the cloud submodel based on the terminal gradients respectively output by the N terminal submodels and the cloud output result; and adjust current parameters of the N terminal submodels and a current parameter of the cloud submodel by using the parameter gradients of the N terminal submodels and the parameter gradient of the cloud submodel. Each of the at least one terminal is configured to: obtain at least one terminal training sample, where each terminal training sample includes a terminal training feature and a sample label, and the cloud training feature includes at least one sub-cloud training feature in a one-to-one correspondence with the at least one terminal training sample; receive, from the server, a cloud output corresponding to the at least one terminal training sample and a current parameter of a terminal submodel run on the terminal, where the cloud output result includes the cloud output; train the terminal submodel run on the terminal by using the cloud output, the current parameter of the terminal submodel run on the terminal, and the at least one terminal training sample to obtain a terminal gradient output by the terminal submodel run on the terminal; and output the terminal gradient output by the terminal submodel run on the terminal to the server.

In a fifth aspect, according to one or more embodiments of the present disclosure, a non-transitory computer-readable storage medium is provided, where the non-transitory computer-readable storage medium stores computer-executable instructions, and the computer-executable instructions, when executed by a processor, implement the model training method according to any one of the embodiments of the present disclosure.

The foregoing description is merely a preferred embodiment of the present disclosure and an illustration of the applied technical principles. A person skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features with similar functions disclosed in the present disclosure (but not limited thereto).

In addition, although the various operations are depicted in a specific order, it should be understood as requiring these operations to be performed in the specific order shown or in a sequential order. Under specific circumstances, multitasking and parallel processing may be advantageous.

Similarly, although several specific implementation details are included in the foregoing discussions, these details should not be construed as limiting the scope of the present disclosure. Some features that are described in the context of separate embodiments may alternatively be implemented in combination in a single embodiment. In contrast, various features described in a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

The following points should be noted for the present disclosure:

(1) The drawings of the embodiments of the present disclosure only relate to the structure involved in the embodiments of the present disclosure, and other structures may refer to the usual designs.

(2) When there is no conflict, the embodiments of the present disclosure and the features in the embodiments may be combined with each other to obtain a new embodiment.

The foregoing descriptions are merely specific implementations of the present disclosure, but are not intended to limit the scope of protection of the present disclosure. The scope of protection of the present disclosure shall be subject to the scope of protection of the claims.

1. A model training method, applied to a server and configured to train a machine learning model,
wherein the machine learning model comprises a cloud submodel and M terminal submodels, the cloud submodel is run on the server, the M terminal submodels are run on at least one terminal, M is a positive integer, and
the model training method comprises:
obtaining a cloud training feature;
training the cloud submodel by using the cloud training feature to obtain a cloud output result of the cloud submodel;
sending the cloud output result and current parameters of the M terminal submodels to the at least one terminal;
receiving terminal gradients respectively output by N terminal submodels in the M terminal submodels that are output by the at least one terminal, wherein N is a positive integer and less than or equal to M, and a terminal gradient output by each of the N terminal submodels comprises a parameter gradient of the terminal submodel and a cloud output gradient;
calculating and obtaining a parameter gradient of the cloud submodel based on the terminal gradients respectively output by the N terminal submodels and the cloud output result; and
adjusting current parameters of the N terminal submodels and a current parameter of the cloud submodel by using the parameter gradients of the N terminal submodels and the parameter gradient of the cloud submodel.

2. The model training method according to claim 1, wherein the M terminal submodels are in a one-to-one correspondence with M pieces of stored training progress information, respectively, and
the M pieces of stored training progress information are stored in the server.

3. The model training method according to claim 2, further comprising:
for each of the at least one terminal:
receiving, from the terminal, current training progress information of each terminal submodel that is run on the terminal; and
adjusting the stored training progress information corresponding to each terminal submodel based on the current training progress information.

4. The model training method according to claim 3, wherein each terminal stores a training sample set for training all terminal submodels that are run on the terminal, the training sample set comprises a plurality of terminal training samples, each terminal training sample comprises a terminal training feature and a sample label,
the terminal training features in the plurality of terminal training samples are sequentially generated in order, and each terminal training sample has a corresponding training progress identifier, and
the current training progress information of each terminal submodel represents a training progress identifier of a last generated terminal training sample in all terminal training samples that is used for training each terminal submodel in the training sample set.

5. The model training method according to claim 1, wherein the at least one terminal comprises a first terminal, and
the obtaining the cloud training feature comprises:
receiving a training request sent by the first terminal, wherein the training request sent by the first terminal comprises identification information of the first terminal; and
obtaining at least one first sub-cloud training feature based on the training request sent by the first terminal,
wherein the cloud training feature comprises the at least one first sub-cloud training feature.

6. The model training method according to claim 5, wherein the at least one terminal further comprises a second terminal, and
obtaining the cloud training feature further comprises:
receiving a training request sent by the second terminal, wherein the training request sent by the second terminal comprises identification information of the second terminal;
obtaining at least one second sub-cloud training feature based on the training request sent by the second terminal; and
performing combining processing on the at least one first sub-cloud training feature and the at least one second sub-cloud training feature to obtain the cloud training feature.

7. The model training method according to claim 6, wherein an absolute value of a time difference between a moment when the training request is sent by the first terminal and a moment when the training request is sent by the second terminal is within a time difference range.

8. The model training method according to claim 1, wherein M is greater than 1, the M terminal submodels comprise a first terminal submodel and a second terminal submodel, the at least one terminal comprises a first terminal and a second terminal, the first terminal submodel is run on the first terminal, the second terminal submodel is run on the second terminal, and
the sending the cloud output result and the current parameters of the M terminal submodels to the at least one terminal comprises:
performing splitting processing on the cloud output result to obtain a first cloud output corresponding to the first terminal submodel and a second cloud output corresponding to the second terminal submodel;
obtaining a current parameter of the first terminal submodel and a current parameter of the second terminal submodel;
transmitting the first cloud output and the current parameter of the first terminal submodel to the first terminal; and
transmitting the second cloud output and the current parameter of the second terminal submodel to the second terminal.

9. The model training method according to claim 1, wherein the M terminal submodels comprise a first terminal submodel and a third terminal submodel, the at least one terminal comprises a first terminal, both the first terminal submodel and the third terminal submodel are run on the first terminal, and
the sending the cloud output result and the current parameters of the M terminal submodels to the at least one terminal comprises:
performing splitting processing on the cloud output result to obtain a first cloud output corresponding to the first terminal submodel and a third cloud output corresponding to the third terminal submodel;
obtaining a current parameter of the first terminal submodel and a current parameter of the third terminal submodel; and
transmitting the first cloud output, the third cloud output, the current parameter of the first terminal submodel, and the current parameter of the third terminal submodel to the first terminal.

10. The model training method according to claim 1, wherein the training the cloud submodel by using the cloud training feature to obtain the cloud output result of the cloud submodel comprises:
obtaining a current parameter of the cloud submodel, wherein the current parameter of the cloud submodel represents a parameter of the cloud submodel when obtaining the cloud training feature; and
training the cloud submodel with the current parameter of the cloud submodel by using the cloud training feature to obtain the cloud output result of the cloud submodel.

11. The model training method according to claim 1, wherein M is greater than 1, N is greater than 1, and
the calculating and obtaining the parameter gradient of the cloud submodel based on the terminal gradients respectively output by the N terminal submodels and the cloud output result comprises:
performing combining processing on cloud output gradients of the N terminal submodels to obtain a combined output gradient; and
calculating and obtaining the parameter gradient of the cloud submodel based on the combined output gradient and the cloud output result.

12. The model training method according to claim 1, wherein inputs of the M terminal submodels match an output of the cloud submodel.

13. The model training method according to claim 1, further comprising:
receiving a training progress query request sent by each terminal, wherein the training progress query request corresponds to a terminal submodel run on the corresponding terminal;
obtaining stored training progress information corresponding to the terminal submodel based on the training progress query request; and
outputting the stored training progress information to the corresponding terminal, for the corresponding terminal to perform a sample screening operation based on the stored training progress information,
wherein in response to obtaining at least one terminal training sample through the sample screening operation, the corresponding terminal sends a training request to the server to perform model training.

14. A model training method, applied to a first terminal and configured to train a machine learning model,
wherein the machine learning model comprises a cloud submodel and a first terminal submodel, the cloud submodel is run on a server, the first terminal submodel is run on the first terminal, and
the model training method comprises:
obtaining at least one terminal training sample, wherein each terminal training sample comprises a terminal training feature and a sample label;
sending a training request to the server based on the at least one terminal training sample;
receiving, from the server, a cloud output corresponding to the at least one terminal training sample and a current parameter of the first terminal submodel;
training the first terminal submodel by using the cloud output, the current parameter of the first terminal submodel, and the at least one terminal training sample to obtain a terminal gradient output by the first terminal submodel, wherein the terminal gradient comprises a parameter gradient of the first terminal submodel and a cloud output gradient; and
outputting the terminal gradient to the server, for the server to calculate and obtain a parameter gradient of the cloud submodel based on the terminal gradient and the cloud output, and to adjust the current parameter of the first terminal submodel and a current parameter of the cloud submodel by using the parameter gradient of the first terminal submodel and the parameter gradient of the cloud submodel.

15. The model training method according to claim 14, wherein the obtaining the at least one terminal training sample comprises:
sending a training progress query request to the server;
receiving, from the server, stored training progress information corresponding to the first terminal submodel;
performing a sample screening operation based on the stored training progress information; and
obtaining the at least one terminal training sample based on K terminal training samples obtained by the sample screening operation, wherein K is a positive integer.

16. The model training method according to claim 14, further comprising:
determining current training progress information corresponding to the first terminal submodel based on the at least one terminal training sample; and
sending the current training progress information to the server, for the server to update the stored training progress information corresponding to the first terminal submodel to the current training progress information.

17. The model training method according to claim 14, wherein the cloud output comprises at least one sub-cloud output in a one-to-one correspondence with the at least one terminal training sample, and
the training the first terminal submodel by using the cloud output, the current parameter of the first terminal submodel, and the at least one terminal training sample to obtain the terminal gradient output by the first terminal submodel comprises:
for each terminal training sample of the at least one terminal training sample:
processing a sub-cloud output corresponding to the terminal training sample and a terminal training feature in the terminal training sample by using the first terminal submodel with the current parameter of the first terminal submodel to obtain an output of the first terminal submodel;
obtaining a loss value of the first terminal submodel based on the output of the first terminal submodel and a sample label in the terminal training sample; and
obtaining the terminal gradient based on the loss value and the output of the first terminal submodel.

18. A model training apparatus, comprising:
one or more memories configured to non-transitorily store computer-executable instructions; and
one or more processors configured to run the computer-executable instructions,
wherein the computer-executable instructions, when run on the one or more processors, implement the model training method according to claim 1.

19. A model training system, configured to train a machine learning model and comprising at least one terminal and a server,
wherein the machine learning model comprises a cloud submodel and M terminal submodels, the cloud submodel is run on the server, the M terminal submodels are run on the at least one terminal, M is a positive integer,
the server is configured to:
obtain a cloud training feature;
train the cloud submodel by using the cloud training feature to obtain a cloud output result of the cloud submodel;
send the cloud output result and current parameters of the M terminal submodels to the at least one terminal;
receive terminal gradients respectively output by N terminal submodels in the M terminal submodels that are output by the at least one terminal, wherein Nis a positive integer and less than or equal to M, and a terminal gradient output by each of the N terminal submodels comprises a parameter gradient of the terminal submodel and a cloud output gradient;
calculate and obtain a parameter gradient of the cloud submodel based on the terminal gradients respectively output by the N terminal submodels and the cloud output result; and
adjust current parameters of the N terminal submodels and a current parameter of the cloud submodel by using the parameter gradients of the N terminal submodels and the parameter gradient of the cloud submodel,
each of the at least one terminal is configured to:
obtain at least one terminal training sample, wherein each terminal training sample comprises a terminal training feature and a sample label, and the cloud training feature comprises at least one sub-cloud training feature in a one-to-one correspondence with the at least one terminal training sample;
receive, from the server, a cloud output corresponding to the at least one terminal training sample and a current parameter of a terminal submodel run on the terminal, wherein the cloud output result comprises the cloud output;
train the terminal submodel run on the terminal by using the cloud output, the current parameter of the terminal submodel run on the terminal, and the at least one terminal training sample to obtain a terminal gradient output by the terminal submodel run on the terminal; and
output the terminal gradient output by the terminal submodel run on the terminal to the server.

20. A non-transitory computer-readable storage medium, wherein the non-transitory computer-readable storage medium stores computer-executable instructions, and the computer-executable instructions, when executed by a processor, implement the model training method according to claim 1.
